(19) United States
(12) Patent Application Publication
(10) Pub. No.: US 2014/0321767 A1
(43) Pub. Date: Oct. 30, 2014

(54) IMAGE PROCESSING DEVICE, IMAGE PROCESSING METHOD, RECORDING MEDIUM, AND STEREOSCOPIC IMAGE DISPLAY DEVICE

(71) Applicant: Sharp Kabushiki Kaisha, Osaka-shi, Osaka (JP)

(72) Inventors: Mikio Seto, Osaka-shi (JP); Hisao Kumai, Osaka-shi (JP); Ikuko Tsubaki, Osaka-shi (JP)

(73) Assignee: Sharp Kabushiki Kaisha, Osaka-shi, Osaka (JP)

(21) Appl. No.: 14/364,116

(22) PCT Filed: Dec. 13, 2012
(86) PCT No.: PCT/JP2012/082335

§ 371 Date: Jun. 10, 2014

(30) Foreign Application Priority Data
Dec. 15, 2011 (JP) 2011-273964

(51) Int. Cl. G06T 5/00

(52) U.S. Cl. CPC G06T 5/002; G06T 5/008; G06T 2207/20192
USPC 382/260; 382/269

(57) ABSTRACT

An unnatural pixel value that appears near the edge of an object included in a viewpoint-changed image, in which a viewpoint is changed, is effectively corrected. A storing portion (12) stores depth data of each pixel of viewpoint-changed image data, an edge extracting portion (15a) extracts the edge of the depth data stored in the storing portion (12), a correction range configuring portion (15b) configures a correction range of the viewpoint-changed image data, based on information on the position of the edge extracted by the edge extracting portion (15a), a processing selecting portion (15c) selects correction processing that is applied to the viewpoint-changed image data, based on information on the pixel value of a pixel of the viewpoint-changed image data, the pixel corresponding to a pixel in the position of the edge extracted by the edge extracting portion (15a), and the pixel value of a pixel of the viewpoint-changed image data, the pixel corresponding to a pixel away from the pixel in the position of the edge by a certain number of pixels, and a processing performing portion (16) performs the correction processing selected by the processing selecting portion (15c).

### TECHNICAL FIELD

The present invention relates to an image processing device and an image processing method that perform correction processing on viewpoint-changed image data in which a viewpoint is changed by converting image data having depth data, a computer program, a recording medium on which the computer program is recorded, and a stereoscopic image display device.

### BACKGROUND ART

Arbitrary viewpoint image generation technology of estimating depth data (also called a depth map) from a plurality of viewpoint images obtained as a result of taking images at different viewpoint positions with a camera, changing this depth data to depth data at a different viewpoint, and then generating a new viewpoint image by using the given viewpoint image has been known. For example, in NPL 1, a method for generating arbitrary viewpoint video by using five cameras is disclosed. In this method, after depth data is extracted, arbitrary viewpoint video is generated by using the depth data and the video from the five cameras.

However, with the method of NPL 1, if the viewpoint position is changed greatly, an occlusion region occurs. The occlusion region is a background region which has been masked by a region which was a foreground in the viewpoint position before the viewpoint is changed and the occlusion region is a region in which the depth data becomes unclear after the viewpoint position is changed. As a method for estimating the depth data of this region, various methods are possible. In NPL 1, estimation of the depth data is performed by linear interpolation based on adjacent depth data.

Further, PTL 1 discloses a virtual viewpoint image generation method by which a depth value of a region which is not seen from a certain viewpoint is interpolated by information from another viewpoint. Specifically, in the method of PTL 1, from a plurality of image data, a plurality of corresponding depth maps are generated. Next, a depth map at an arbitrary viewpoint is generated based on the depth map corresponding to a viewpoint position closest to the position of the arbitrary viewpoint. Then, the depth value of an occlusion portion that occurs in this depth map at the arbitrary viewpoint is interpolated based on the depth map seen from another viewpoint position and discontinuous portions in the depth map at the arbitrary viewpoint are smoothed. Based on the depth map generated in this manner and the images at a plurality of viewpoints, an image at an arbitrary viewpoint is generated.

### CITATION LIST

### Patent Literature

PTL 1: Japanese Patent No. 3593466

### Non Patent Literature

NPL 1: Park Jong Il, Seiki INOUE, “New View Generation from Multi-View Image Sequence”, Technical Report (IE96-121), IEICE, February 1997, pp. 91-98

### SUMMARY OF INVENTION

### Technical Problem

However, with the existing technologies described above, there is a possibility that a jaggy or an artifact (a pixel having an unnatural pixel value) occurs in an edge portion of an object in an arbitrary viewpoint image. This point will be described in detail below.

FIG. 13 is a diagram describing an example of a change in an image caused when a viewpoint position is changed. As depicted in FIG. 13(A) and FIG. 13(B), in the arbitrary viewpoint image generation technology, it is possible to generate an arbitrary viewpoint image 4 at an arbitrary viewpoint (a viewpoint B) based on a reference image 3 taken at a viewpoint A and depth data. However, if there is a gradation region in the reference image 3, there is a possibility that a jaggy or an artifact occurs in the arbitrary viewpoint image 4.

FIG. 14 is a diagram describing an example of the occurrence of a jaggy in the arbitrary viewpoint image 4, and FIG. 15 is a diagram describing an example of the occurrence of an artifact in the arbitrary viewpoint image 4. For example, as depicted in an enlarged view 3a of the reference image 3, a gradation region 3b is sometimes present near the edge of an object 2. The gradation region 3b is caused as a result of, for example, anti-aliasing being performed on an image or both a light beam from the foreground and a light beam from the background entering the pixels of an image pickup device of the camera when taking images.

In FIG. 14, depth data 5a in the case of the gradation region 3b being present in a background portion of the reference image 3 is depicted. For example, the depth data 5a indicates that the whiter a portion, the closer a subject to the front; the blacker a portion, the farther the subject from the front.

Then, when the viewpoint is changed and an object 1 and the object 2 overlap one another as in the arbitrary viewpoint image 4, as depicted in an enlarged view 4a of the arbitrary viewpoint image 4, the gradation region 3b disappears and a jaggy region 4b occurs.

Moreover, in FIG. 15, depth data 5b in the case of the gradation region 3b being present in a portion of the object 2 in the reference image 3 is depicted. Then, when the viewpoint is changed and the object 1 and the object 2 overlap one another as in the arbitrary viewpoint image 4, as depicted in an enlarged view 4a of the arbitrary viewpoint image 4, the gradation region 3b disappears and an artifact region 4c occurs.

When a region which seems unnatural to the eye, such as the jaggy region 4b or the artifact region 4c, occurs, it is necessary to perform appropriate correction to eliminate such unnaturalness in accordance with the type of the region thus occurred, but a method for performing correction appropriately is not disclosed in the above-described existing technologies.

In view of the circumstances described above, an object of the present invention is to provide an image processing device and an image processing method that can effectively correct an unnatural pixel value that appears near the edge of an object in an image at a changed viewpoint, a computer program that causes a computer to perform the image processing method, and a computer-readable recording medium on which the computer program is recorded.

### Solution to Problem

To solve the above-described problems, a first technical means of the present invention is an image processing device that performs correction processing on viewpoint-changed image data in which a viewpoint is changed by converting image data having depth data. The image processing device includes: a storing portion that stores depth data of each pixel of the viewpoint-changed image data; an edge extracting portion that extracts the edge of the depth data stored in the storing portion; a correction range configuring portion that configures a correction range of the viewpoint-changed image data, based on information on the position of the edge extracted by the edge extracting portion; a processing selecting portion that selects correction processing that is applied to the viewpoint-changed image data, based on information on the pixel value of a pixel of the viewpoint-changed image data, the pixel corresponding to a pixel in the position of the edge extracted by the edge extracting portion, and the pixel value of a pixel of the viewpoint-changed image data, the pixel corresponding to a pixel away from the pixel in the position of the edge by a certain number of pixels; and a processing performing portion that performs the correction processing selected by the processing selecting portion.

In a second technical means of the present invention according to the first technical means, extraction of the edge is performed by using a two-dimensional filter.

In a third technical means of the present invention according to the first or second technical means, the correction range configuring portion configures, as the correction range, the range of pixels of the viewpoint-changed image data, the pixels corresponding to pixels in a certain range including the pixel in the position of the edge.

In a fourth technical means of the present invention according to the first or second technical means, the correction range configuring portion detects the size of an image formed by the viewpoint-changed image data and configures the correction range based on information on the size and the information on the position of the edge.

In a fifth technical means of the present invention according to the first or second technical means, the correction range configuring portion accepts input information for configuring correction range, the input information being input by a user, and configures the correction range based on the input information.

In a sixth technical means of the present invention according to any one of the first to fifth technical means, the processing selecting portion specifies the certain number of pixels based on the correction range.

In a seventh technical means of the present invention according to any one of the first to sixth technical means, the correction range configuring portion configures the correction range at different ranges in accordance with the correction processing selected by the processing selecting portion.

In an eighth technical means of the present invention according to any one of the first to seventh technical means, the correction processing is correction processing for correcting a jaggy or correction processing for correcting an artifact.

In a ninth technical means of the present invention according to any one of the first to eighth technical means, the edge extracting portion further extracts the edge of depth data corresponding to image data before change of the viewpoint, and the correction range configuring portion configures the correction range based on information on the position of the edge of the depth data stored in the storing portion and information on the position of the edge of the depth data before change of the viewpoint.

A tenth technical means of the present invention is an image processing method that performs correction processing on viewpoint-changed image data in which a viewpoint is changed by converting image data having depth data. The image processing method includes: an edge extracting step of extracting the edge of depth data of each pixel of the viewpoint-changed image data stored in a storing portion; a correction range configuring step of configuring a correction range of the viewpoint-changed image data, based on information on the position of the edge extracted in the edge extracting step; a processing selecting step of selecting correction processing that is applied to the viewpoint-changed image data, based on information on the pixel value of a pixel of the viewpoint-changed image data, the pixel corresponding to a pixel in the position of the edge extracted in the edge extracting step, and the pixel value of a pixel of the viewpoint-changed image data, the pixel corresponding to a pixel away from the pixel in the position of the edge by a certain number of pixels; and a processing performing step of performing the correction processing selected in the processing selecting step.

In an eleventh technical means of the present invention according to the tenth technical means, in the processing selecting step, the certain number of pixels is specified based on the correction range.

In a twelfth technical means of the present invention according to the tenth or eleventh technical means, in the correction range configuring step, the correction range is configured at different ranges in accordance with the correction processing selected in the processing selecting step.

In a thirteenth technical means of the present invention according to any one of the tenth to twelfth technical means, in the edge extracting step, the edge of depth data corresponding to image data before change of the viewpoint is further extracted, and, in the correction range configuring step, the correction range is configured based on information on the position of the edge of the depth data stored in the storing portion and information on the position of the edge of the depth data before change of the viewpoint.

A fourteenth technical means of the present invention is a computer program that causes a computer to perform the image processing method according to any one of the tenth to thirteenth technical means.

A fifteenth technical means of the present invention is a computer-readable recording medium that stores the computer program according to the fourteenth technical means.

A sixteenth technical means of the present invention is a stereoscopic image display device that includes the image processing device according to any one of the first to ninth technical means and a display device that displays the viewpoint-changed image data on which correction processing has been performed by the image processing device.

### Advantageous Effects of Invention

According to the present invention, since the edge of depth data of each pixel of viewpoint-changed image data is extracted, a correction range of the viewpoint-changed image data is configured based on information on the position of the extracted edge, correction processing that is applied to the viewpoint-changed image data is selected based on information on the pixel value of a pixel of the viewpoint-changed image data, the pixel corresponding to a pixel in the position of the extracted edge, and the pixel value of a pixel of the viewpoint-changed image data, the pixel corresponding to a pixel away from the pixel in the position of the edge by a certain number of pixels, and the selected correction processing is performed, it is possible to correct effectively an unnatural pixel value that appears near the edge of an object included in an image obtained at a changed viewpoint.

### BRIEF DESCRIPTION OF DRAWINGS

FIG. 1 is a diagram depicting an example of the configuration of an image processing device according to a first embodiment of the present invention.

FIG. 2 is a diagram describing an example of correction range configuring processing.

FIG. 3 is a diagram describing an example of a correction processing selection method.

FIG. 4 is a diagram describing an example of jaggy correction processing.

FIG. 5 is a diagram describing an example of artifact correction processing.

FIG. 6 is a flowchart depicting an example of the procedure of image processing according to an embodiment of the present invention.

FIG. 7 is a flowchart depicting an example of processing of generation of depth data after change of the viewpoint.

FIG. 8 is a flowchart depicting an example of arbitrary viewpoint image data correction processing.

FIG. 9 is a flowchart depicting an example of the procedure of the jaggy correction processing.

FIG. 10 is a flowchart depicting an example of the procedure of the artifact correction processing.

FIG. 11 is a diagram depicting an example of the configuration of an image processing device 10 according to a second embodiment of the present invention.

FIG. 12 is a diagram describing edge information integration processing according to the second embodiment of the present invention.

FIG. 13 is a diagram describing an example of a change in an image observed when a viewpoint position is changed.

FIG. 14 is a diagram describing an example of the occurrence of a jaggy in an arbitrary viewpoint image.

FIG. 15 is a diagram describing an example of the occurrence of an artifact in the arbitrary viewpoint image.

### DESCRIPTION OF EMBODIMENTS

### First Embodiment

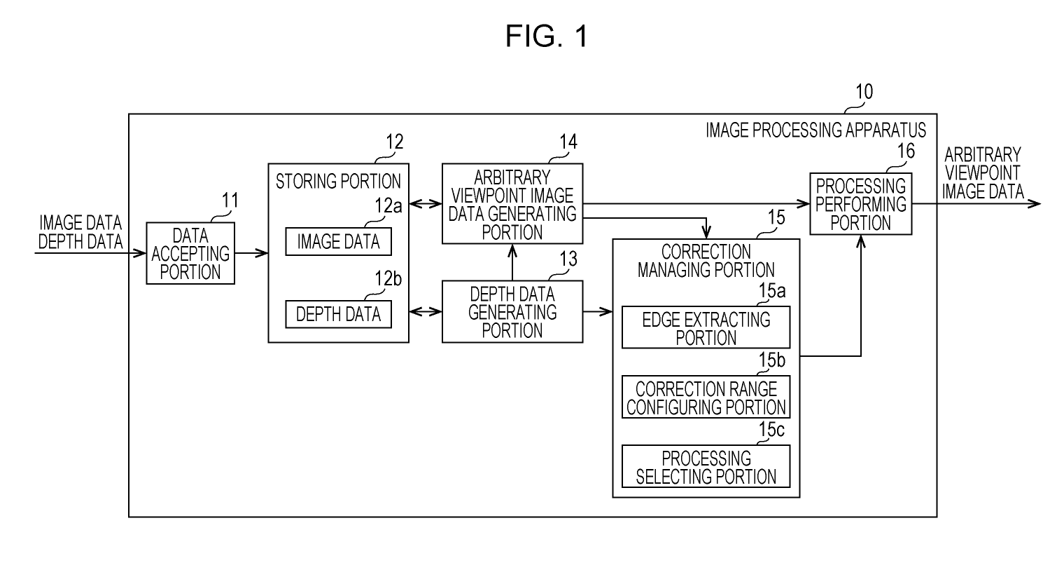

Hereinafter, a first embodiment of the present invention will be described in detail with reference to the drawings. FIG. 1 is a diagram depicting an example of the configuration of an image processing device 10 according to the first embodiment of the present invention. As depicted FIG. 1, the image processing device 10 includes a data accepting portion 11, a storing portion 12, a depth data generating portion 13, an arbitrary viewpoint image data generating portion 14, a correction managing portion 15, and a processing performing portion 16.

The data accepting portion 11 is a processing portion that accepts image data and depth data from an external device and causes the storing portion 12 to store the accepted image data and depth data.

Here, the image data is, for example, image data taken by a camera, image data recorded on a recording medium such as read only memory (ROM), or image data received by a tuner or the like. Moreover, the image data may be image data for stereoscopy or image data taken at a plurality of viewpoints necessary for generation of an arbitrary viewpoint image.

Moreover, the depth data is data containing a disparity value or depth information such as a distance to an object. For example, when the image data is image data for stereoscopy, the depth data may be data containing a disparity value calculated from the image data for stereoscopy; when the image data is image data taken by a camera, the depth data may be data containing the distance measured by a distance measuring device of the camera.

The disparity value and the distance can be changed based on the following Equation 1.

Z(x,y)=bf/d(x,y) (Equation 1)

Here, Z(x, y) represents the distance at coordinates (x, y) of a pixel on an image, b represents a base line length, f represents a focal length, and d(x, y) represents a disparity value at coordinates (x, y) of the pixel on the image.

The storing portion 12 is a storage device such as memory or a hard disk. The storing portion 12 stores image data 12a and depth data 12b. The image data 12a includes image data obtained from the data accepting portion 11 and arbitrary viewpoint image data (viewpoint-changed image data) after change of the viewpoint, the arbitrary viewpoint image data (viewpoint-changed image data) being generated by the arbitrary viewpoint image data generating portion 14. Moreover, the depth data 12b includes depth data obtained from the data accepting portion 11 and depth data after change of the viewpoint, the depth data being generated by the depth data generating portion 13. Hereinafter, descriptions will be given on the assumption that the depth data 12b includes information on a disparity value.

The depth data generating portion 13 is a processing portion that reads depth data before change of the viewpoint from the storing portion 12 and generates depth data after change of the viewpoint by using the read depth data. Since the position in which an object is seen on the image and the way in which objects overlap one another are changed when the viewpoint is changed, the depth data generating portion 13 corrects the disparity value of the depth data before change of the viewpoint in accordance with such a change. Specific processing that is performed by the depth data generating portion 13 will be described in detail later.

The arbitrary viewpoint image data generating portion 14 is a processing portion that generates, by using the image data 12a, the depth data before change of the viewpoint, and the depth data after change of the viewpoint, the depth data being generated by the depth data generating portion 13, arbitrary viewpoint image data in which the relationship between the foreground and the background is adjusted.

For example, the arbitrary viewpoint image data generating portion 14 generates the arbitrary viewpoint image data by using the techniques described in NPL 1 and PTL 1 or an arbitrary viewpoint image generation method that is performed based on geometric transformation such as a ray-space method.

The correction managing portion 15 is a processing portion that manages correction processing which is performed on the arbitrary viewpoint image data. The correction managing portion 15 includes an edge extracting portion 15a, a correction range configuring portion 15b, and a processing selecting portion 15c.

The edge extracting portion 15a is a processing portion that extracts the edge of the depth data after change of the viewpoint, the depth data being generated by the depth data generating portion 13. For example, the edge extracting portion 15a extracts the edge by using a common edge extraction method such as Sobel filtering, Laplacian filtering, or a difference operation performed on the pixel values of adjacent pixels. Here, the filter used for extraction of the edge may be a one-dimensional filter or a two-dimensional filter. By using the two-dimensional filter, it is possible to extract effectively the edge of the depth data formed of two-dimensional coordinates.

The correction range configuring portion 15b is a processing portion that configures the correction range of the arbitrary viewpoint image by using the information on the edge extracted by the edge extracting portion 15a. Specifically, the correction range configuring portion 15b configures the correction range of the arbitrary viewpoint image based on the information on the position of the edge extracted by the edge extracting portion 15a.

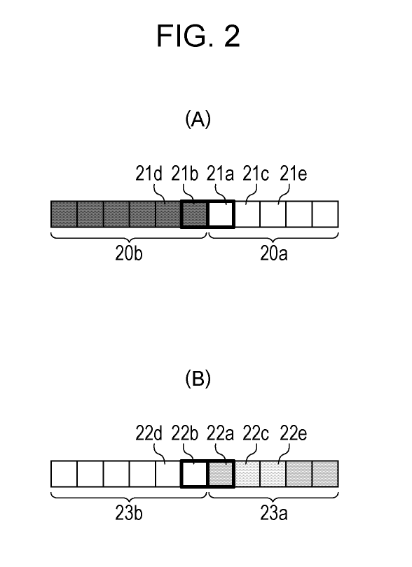

FIG. 2 is a diagram describing an example of correction range configuring processing. In FIG. 2(A), two regions 20a and 20b whose disparity values greatly differ from each other in the depth data after change of the viewpoint are depicted. The region 20a is a region with a greater disparity value, and the region 20b is a region with a smaller disparity value. Moreover, pixels 21a and 21b are pixels located in the position of the edge extracted by the edge extracting portion 15a. Hereinafter, of the pixels 21a and 21b, the pixel 21a with a greater disparity value is referred to as a “foreground-side pixel” and the pixel 21b with a smaller disparity value is referred to as a “background-side pixel”.

Moreover, in FIG. 2(B), pixels 22a to 22e of the arbitrary viewpoint image, the pixels 22a to 22e respectively corresponding to pixels 21a to 21e of the depth data after change of the viewpoint, and regions 23a and 23b respectively corresponding to the regions 20a and 20b of the depth data after change of the viewpoint are depicted.

For example, the correction range configuring portion 15b detects a range with two pixels, each being away from the foreground-side pixel 21a by N pixels, at both ends thereof. Then, the correction range configuring portion 15b configures the range of the pixels of the arbitrary viewpoint image, the range corresponding to the detected range, as the correction range.

The correction range configuring portion 15b determines N as follows, for example.

(1) The correction range configuring portion 15b configures N at a fixed certain value. For example, the correction range configuring portion 15b configures N at 3 or the like. With this method, it is possible to configure the correction range easily.
(2) The correction range configuring portion 15b detects the size of the arbitrary viewpoint image and configures N based on the size. For example, the correction range configuring portion 15b calculates N by using an equation: N=round(0.005×width). Here, width is the number of horizontal pixels of the arbitrary viewpoint image, and round(x) is a function that rounds off x. For example, when width=1920, N=10. With this method, it is possible to configure the correction range appropriately in accordance with the size of the arbitrary viewpoint image.
(3) The correction range configuring portion 15b configures N based on an instruction from the user. For example, the correction range configuring portion 15b makes it possible for the user to select N from 1 to 10 and accepts the selection of N from the user by using a remote control device (not depicted) or the like. With this method, the user can configure the correction range according to the user's wishes.

Furthermore, the correction range configuring portion 15b may correct the correction range configured in the manner described above in accordance with the processing selected by the processing selecting portion 15c, which will be described below. For example, the correction range configuring portion 15b corrects the correction range depending on whether jaggy correction is selected or artifact correction is selected. A specific correction method will be described in detail later.

The processing selecting portion 15c is a processing portion that selects correction processing which will be performed on the arbitrary viewpoint image. For example, the processing selecting portion 15c compares the pixel value of a pixel on the arbitrary viewpoint image, the pixel corresponding to a pixel in the position of the edge extracted by the edge extracting portion 15a, with the pixel value of a pixel on the arbitrary viewpoint image, the pixel corresponding to a pixel away from the pixel in the position of the edge by a certain number of pixels, and selects correction processing based on the comparison result.

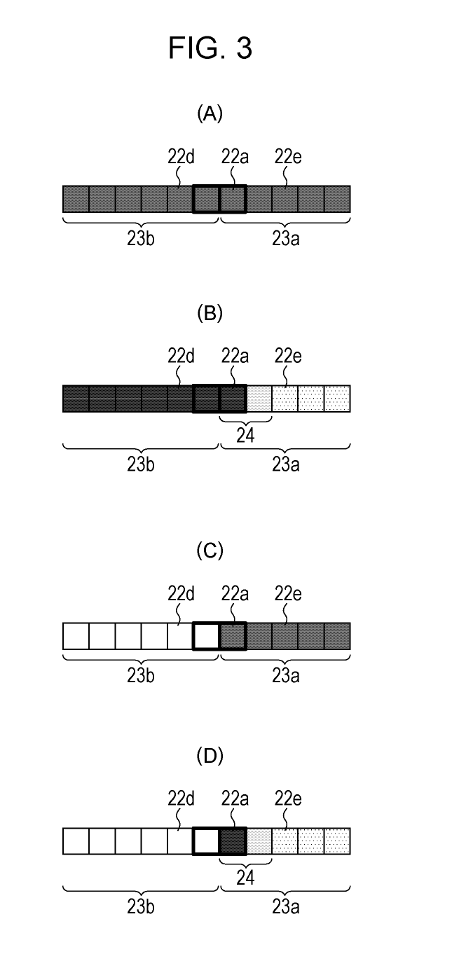

FIG. 3 is a diagram describing an example of a correction processing selection method. In FIG. 3, the pixel 22a is a pixel of the arbitrary viewpoint image, the pixel corresponding to the foreground-side pixel 21a in the depth data after change of the viewpoint depicted in FIG. 2. Moreover, the pixels 22d and 22e are pixels in positions away from the pixel 22a by M pixels. In the example of FIG. 3, M=2.

When correction processing is selected, the processing selecting portion 15c compares the pixel value of the pixel 22a on the arbitrary viewpoint image, the pixel 22a corresponding to the foreground-side pixel 21a, with the pixel values of the pixels 22d and 22e on the arbitrary viewpoint image, the pixels 22d and 22e corresponding to the pixels 21d and 21e in positions away from the foreground-side pixel 21a by a certain number of pixels M. As the value of M, for example, N+1 is used. In this case, a pixel located outside the correction range by one pixel is used as a target for comparison. As described above, by determining the value of M based on the correction range, it is possible to select appropriate correction processing in accordance with the correction range.

In FIGS. 3(A) to 3(D), the distribution of the pixel values in the arbitrary viewpoint image is depicted. The regions 23a and 23b are regions corresponding to the two regions 20a and 20b in the depth data after change of the viewpoint depicted in FIG. 2(A).

For example, assume that the pixel values of the pixels 22a and 22d of the arbitrary viewpoint image are A and D, the pixels 22a and 22d respectively corresponding to the foreground-side pixel 21a and the background-side pixel 21d in a position away from the foreground-side pixel 21a by a certain number of pixels M. In this case, the processing selecting portion 15c determines whether or not |A−D| is smaller than a predetermined threshold value TH1. A case where |A−D| is smaller than the predetermined threshold value TH1 is each case depicted in FIG. 3(A) and FIG. 3(B), for example. As the pixel value, a luminance value may be used, or a gradation value of RGB may be used.

In FIG. 3(A), the region 23a and the region 23b have about the same pixel values. Therefore, a jaggy does not occur markedly, and jaggy correction processing is not performed. In FIG. 3(B), a gradation region 24 occurs in part of the region 23a, but the pixel value of the pixel 22a is nearly equal to the pixel value of the pixel 22d. Therefore, an artifact does not occur markedly, and correction processing is not performed.

A case where |A−D| is greater than or equal to the predetermined threshold value TH1 is each case depicted in FIG. 3(C) and FIG. 3(D), for example. In this case, the processing selecting portion 15c further determines whether or not |A−E| is smaller than a predetermined threshold value TH2. Here, E is a pixel value of the pixel 22e of the arbitrary viewpoint image, the pixel 22e corresponding to the pixel 21e on the foreground side in a position away from the foreground-side pixel 21a by a certain number of pixels M.

A case where |A−E| is smaller than the predetermined threshold value TH2 is a case depicted in FIG. 3(C), for example. In this case, there is a possibility that a jaggy occurs markedly. Therefore, the processing selecting portion 15c selects the jaggy correction processing. A case where |A−E| is greater than or equal to the predetermined threshold value TH2 is a case depicted in FIG. 3(D), for example. In this case, there is a possibility that an artifact occurs markedly. Therefore, the processing selecting portion 15c selects artifact correction processing.

When the correction processing is selected by the processing selecting portion 15c, as described earlier, the correction range configuring portion 15b may correct the correction range of the arbitrary viewpoint image in accordance with the selected processing.

For example, when jaggy correction is performed, the correction range configuring portion 15b detects a range with two pixels, each being away from the foreground-side pixel 21a by M pixels, at both ends thereof in the depth data after change of the viewpoint. Here, the number of pixels M is the same number of pixels as the number of pixels M used by the processing selecting portion 15c to select correction processing. Then, the correction range configuring portion 15b corrects the correction range to the range of the pixels of the arbitrary viewpoint image, the range corresponding to the detected range.

For example, when M=2, in FIG. 2, the correction range configuring portion 15b detects a range with two pixels 21d and 21e, each being away from the foreground-side pixel 21a by two pixels, at both ends thereof. Then, the correction range configuring portion 15b corrects the correction range to the range in which the pixels 22d, 22b, 22a, 22c, and 22e of the arbitrary viewpoint image are present, the range corresponding to the detected range.

When artifact correction is performed, the correction range configuring portion 15b detects a range with the foreground-side pixel 21a at one end and a pixel in the region 20a, the pixel being away from the foreground-side pixel 21a by M pixels, at the other end in the depth data after change of the viewpoint. Then, the correction range configuring portion 15b corrects the correction range to the range of the pixels of the arbitrary viewpoint image, the range corresponding to the detected range.

For example, when M=2, in FIG. 2, the correction range configuring portion 15b detects a range with the foreground-side pixel 21a at one end and the pixel 21e at the other end. Then, the correction range configuring portion 15c corrects the correction range to the range in which the pixels 22a, 22c, and 22e of the arbitrary viewpoint image are present, the range corresponding to the detected range.

As described above, by configuring the correction range to different ranges in accordance with the correction processing, it is possible to perform appropriate correction in accordance with the correction processing. Here, a case has been described where the already configured correction range is corrected after the correction processing is selected; however, the correction range may be configured for the first time in accordance with selected correction processing after correction processing is selected.

The processing performing portion 16 is a processing portion that performs the correction processing selected by the processing selecting portion 15c on the correction range configured by the correction range configuring portion 15b and outputs an image on which the correction processing has been performed.

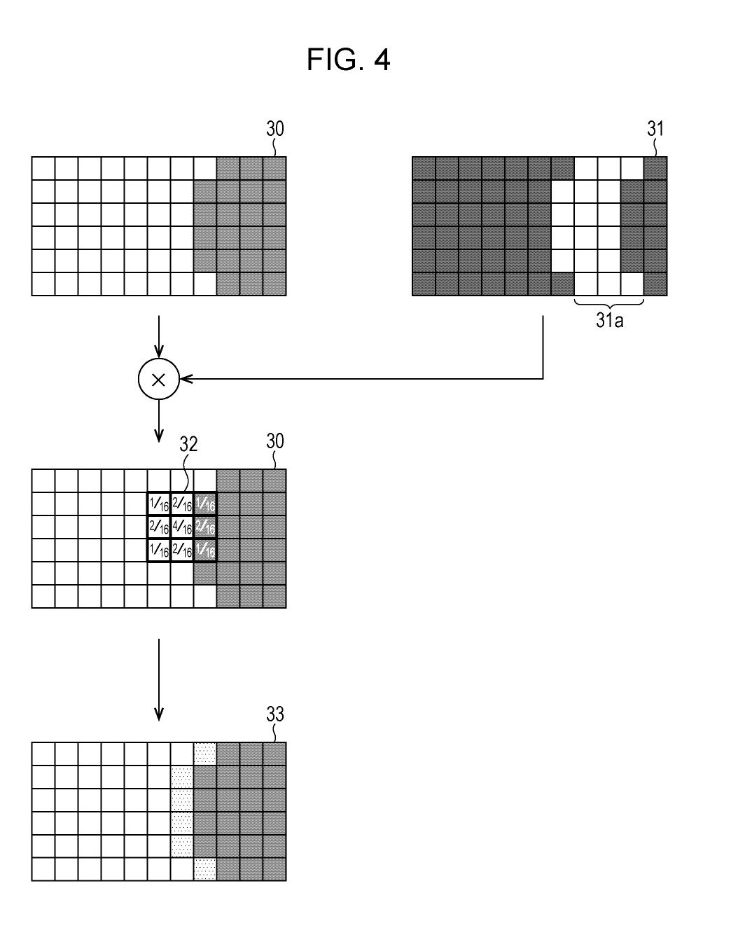

FIG. 4 is a diagram describing an example of the jaggy correction processing. In FIG. 4, an arbitrary viewpoint image 30 and correction range information 31 are depicted. The correction range information 31 is information on a correction range 31a for jaggy correction, the correction range 31a being configured for the arbitrary viewpoint image 30 by the correction range configuring portion 15b.

The processing performing portion 16 refers to the correction range information 31 and smoothes the pixel values of the pixels of the arbitrary viewpoint image 30 included in the correction range 31a. For example, the processing performing portion 16 performs smoothing by using a Gaussian filter. In FIG. 4, a 3×3 Gaussian filter 32 is depicted. As a result, an arbitrary viewpoint image 33 in which the jaggy is reduced is obtained.

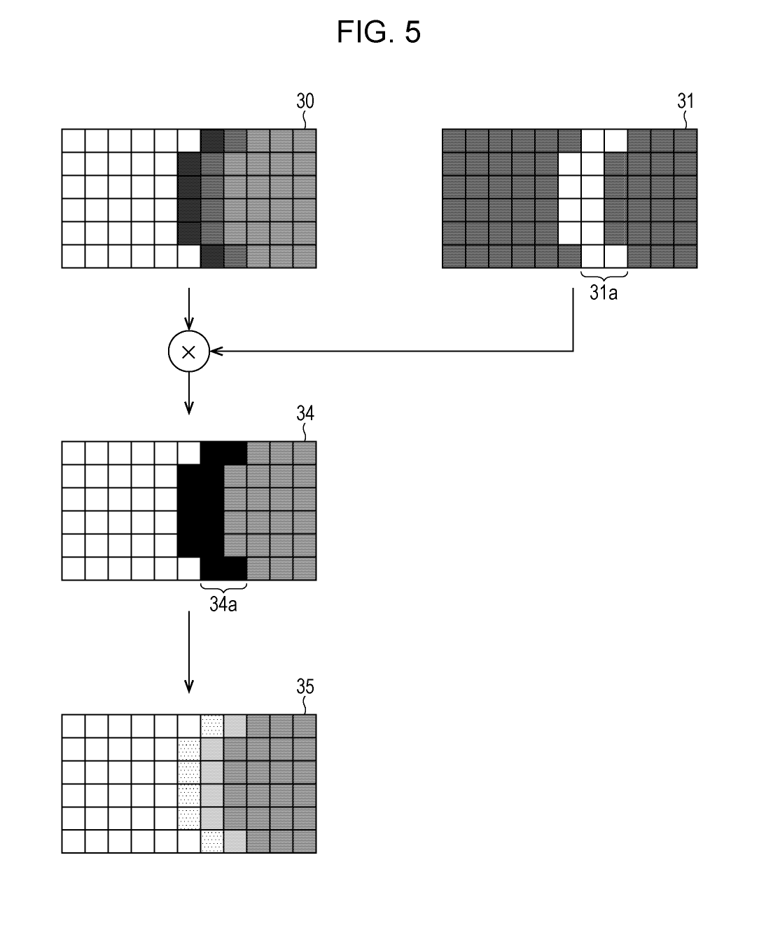

FIG. 5 is a diagram describing an example of the artifact correction processing. In FIG. 5, an arbitrary viewpoint image 30 and correction range information 31 are depicted. The correction range information 31 is information on a correction range 31a for artifact correction, the correction range 31a being configured for the arbitrary viewpoint image 30 by the correction range configuring portion 15b.

The processing performing portion 16 refers to the correction range information 31 and generates an arbitrary viewpoint image 34 in which each of the pixel values of the pixels of the arbitrary viewpoint image 30 corresponding to the correction range 31a is configured at an indefinite value 34a. Then, the processing performing portion 16 interpolates the pixel value of each pixel, the pixel value being configured at the indefinite value 34a, by using the pixel values of peripheral pixels. For example, the processing performing portion 16 performs the above-described interpolation processing by using various techniques such as bilinear interpolation and bicubic interpolation. As a result, an arbitrary viewpoint image 35 in which the artifact is reduced is obtained.

Also for jaggy correction, the same technique as that of artifact correction may be used. Moreover, in FIGS. 2 to 5, a case where two horizontally-arranged, adjacent pixels are detected as the edge has been described. However, also in a case where two vertically-arranged, adjacent pixels are detected as the edge, it is possible to perform jaggy correction or artifact correction easily by regarding the x direction of FIGS. 2 to 5 as the y direction. As described above, by performing jaggy correction or artifact correction as the correction processing, it is possible to reduce a jaggy or an artifact effectively.

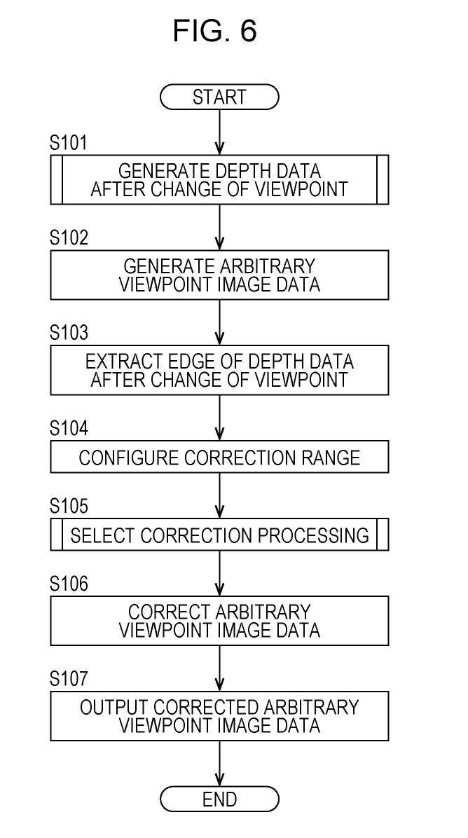

Next, the procedure of image processing according to the embodiment of the present invention will be described. FIG. 6 is a flowchart depicting an example of the procedure of the image processing according to the embodiment of the present invention. First, the depth data generating portion 13 of the image processing device generates depth data after change of the viewpoint by using depth data before change of the viewpoint (step S101).

Then, the arbitrary viewpoint image data generating portion 14 generates, by using image data 12a, the depth data before change of the viewpoint, and the depth data after change of the viewpoint, arbitrary viewpoint image data in which the relationship between the foreground and the background is adjusted (step S102).

Next, the edge extracting portion 15a extracts the edge of the depth data after change of the viewpoint (step S103). Then, the correction range configuring portion 15b configures the correction range of an arbitrary viewpoint image by using information on the position of the edge extracted by the edge extracting portion 15a (step S104).

Then, the processing selecting portion 15c selects correction processing to be performed on the arbitrary viewpoint image data by using information on the pixel value of a pixel of the arbitrary viewpoint image data, the pixel corresponding to a pixel in the position of the edge extracted by the edge extracting portion 15a, and the pixel value of a pixel of the arbitrary viewpoint image data, the pixel corresponding to a pixel away from the pixel in the position of the edge by a certain number of pixels (step S105).

Then, the processing performing portion 16 performs the correction processing selected by the processing selecting portion 15c on the correction range of the arbitrary viewpoint image data, the correction range being configured by the correction range configuring portion 15b (step S106). Then, the processing performing portion 16 outputs the arbitrary viewpoint image data on which the correction processing has been performed (step S107), and the image processing is ended.

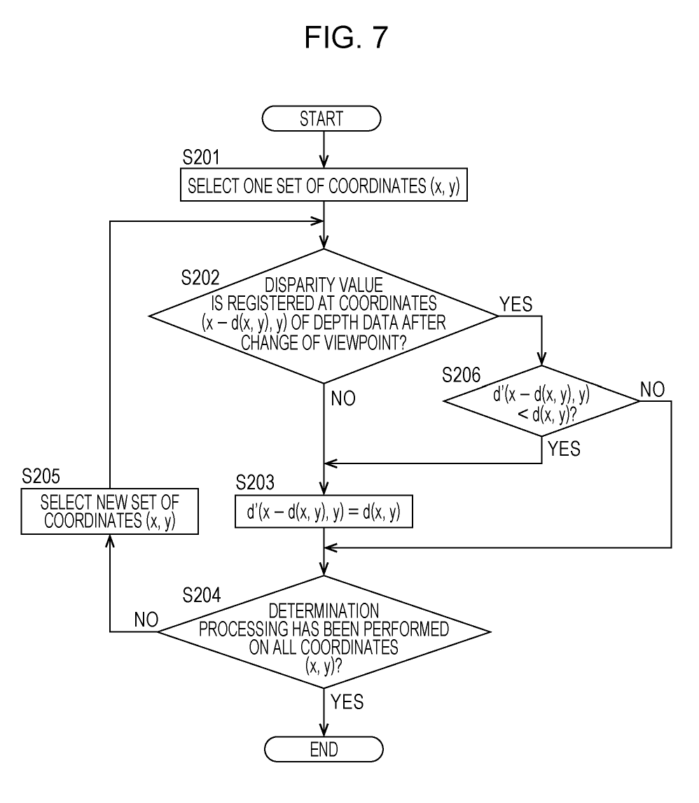

Next, processing of generation of the depth data after change of the viewpoint depicted in step S101 of FIG. 6 will be described. FIG. 7 is a flowchart depicting an example of the processing of generation of the depth data after change of the viewpoint.

Here, as an example, the description deals with a case where the viewpoint is shifted parallel to the x axis. In this case, if the assumption is made that a pixel at coordinates (x, y) of depth data before change of the viewpoint and a pixel at coordinates (X, Y) of depth data after change of the viewpoint are corresponding points and d(x, y) is a disparity value at coordinates (x, y) of the depth data before change of the viewpoint, d(x, y)=x−X and Y=y.

First, the depth data generating portion 13 selects one set of coordinates (x, y) (step S201). Then, the depth data generating portion 13 determines whether or not a disparity value is registered at coordinates (x−d(x, y), y) of the depth data after change of the viewpoint (step S202). It is assumed that a disparity value is not registered in an initial state at all coordinates (X, Y) of the depth data after change of the viewpoint.

If a disparity value is not registered at the coordinates (x−d(x, y), y) (NO in step S202), the depth data generating portion 13 configures a disparity value d′(x−d(x, y), y) of the depth data after change of the viewpoint as the disparity value d(x, y) (step S203).

If a disparity value is registered at the coordinates (x−d(x, y), y) in step S202 (YES in step S202), the depth data generating portion 13 determines whether or not the registered disparity value d′(x−d(x, y), y) is smaller than the disparity value d(x, y) (step S206).

If the disparity value d′(x−d(x, y), y) is smaller than the disparity value d(x, y) (YES in step S206), the procedure proceeds to step S203, the depth data generating portion 13 updates the disparity value d′(x−d(x, y), y) to the disparity value d(x, y), and the processing after step S204 is continuously performed.

If the disparity value d′(x−d(x, y), y) is greater than or equal to the disparity value d(x, y) (NO in step S206), the procedure proceeds to step S204, and the processing after step S204 is continuously performed.

In step S204, the depth data generating portion 13 determines whether or not the determination processing in step S202 has been performed on all the coordinates (x, y) (step S204). If the determination processing in step S202 has been performed on all the coordinates (x, y) (YES in step S204), the processing of generation of the depth data after change of the viewpoint is ended.

If the determination processing in step S202 is not completed (NO in step S204), the depth data generating portion 13 selects a new set of coordinates (x, y) (step S205) and performs the processing after step S202 on the selected coordinates (x, y). By the processing described above, the depth data after change of the viewpoint is generated.

That is, here, processing for registering a greater disparity value, that is, the disparity value of an object located closer to the front on the depth data after change of the viewpoint is performed. As a result, even when the position of an object or overlapping of objects is changed by a change of the viewpoint, a disparity value after change of the viewpoint is appropriately configured.

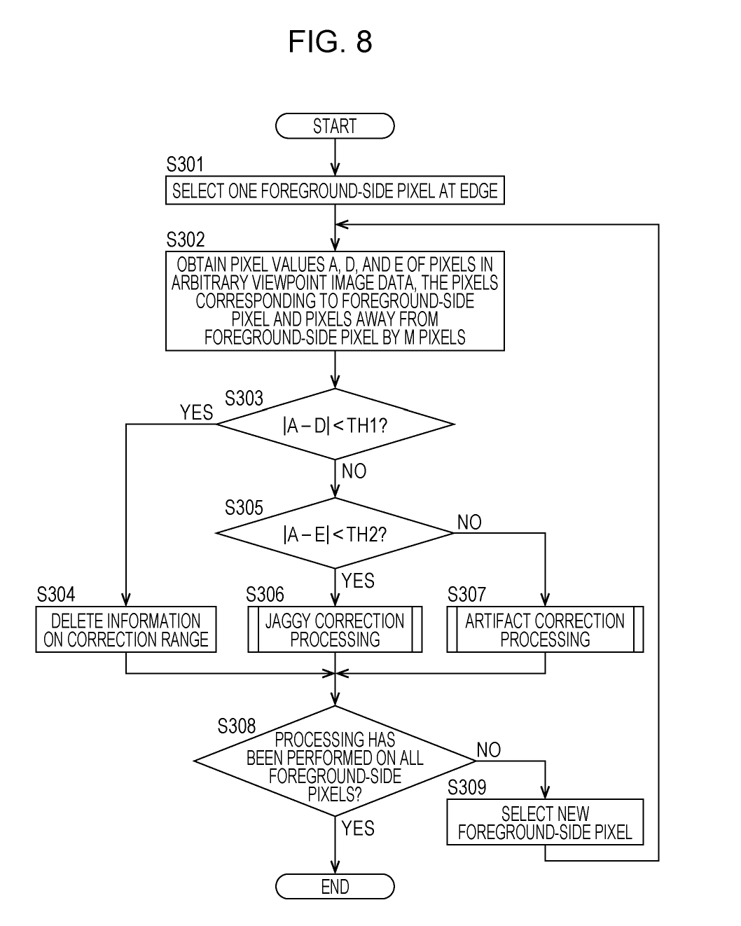

Next, processing of correction of the arbitrary viewpoint image data described in step S105 of FIG. 6 will be described. FIG. 8 is a flowchart depicting an example of the processing of correction of the arbitrary viewpoint image data.

First, as described by using FIGS. 2 and 3, the processing selecting portion 15c selects one foreground-side pixel 21a at the edge (step S301). Then, the processing selecting portion 15c obtains the pixel values A, D, and E of the pixels 22a, 22d, and 22e in the arbitrary viewpoint image data, the pixels 22a, 22d, and 22e respectively corresponding to the foreground-side pixel 21a and the pixels 21d and 21e away from the foreground-side pixel 21a by M pixels (step S302).

Here, as described by using FIGS. 2 and 3, A is the pixel value of the pixel 22a of the arbitrary viewpoint image, the pixel 22a corresponding to the foreground-side pixel 21a, D is the pixel value of the pixel 22d in the region 23b which is different from the region 23a to which the pixel 22a belongs, and E is the pixel value of the pixel 22e in the region 23a to which the pixel 22a belongs.

Then, the processing selecting portion 15c determines whether or not |A−D| is smaller than the predetermined threshold value TH1 (step S303). If |A−D| is smaller than the predetermined threshold value TH1 (YES in step S303), the correction range information on the selected foreground-side pixel 21a is deleted (step S304).

If |A−D| is greater than or equal to the predetermined threshold value TH1 in step S303 (NO in step S303), the processing selecting portion 15c further determines whether or not |A−E| is smaller than the predetermined threshold value TH2 (step S305).

If |A−E| is smaller than the predetermined threshold value TH2 (YES in step S305), the processing performing portion 16 performs jaggy correction processing (step S306). The jaggy correction processing will be described in detail later.

If |A−E| is greater than or equal to the predetermined threshold value TH2 (NO in step S305), the processing performing portion 16 performs artifact correction processing (step S307). The artifact correction processing will be described in detail later.

After the processing in step S304, step S306, or step S307, the processing selecting portion 15c determines whether or not the processing in step S302 has been performed on all the foreground-side pixels 21a (step S308).

If the processing in step S302 has been performed on all the foreground-side pixels 21a (YES in step S308), the processing of correction of the arbitrary viewpoint image data is ended. If the processing in step S302 has not been performed on all the foreground-side pixels 21a (NO in step S308), the processing selecting portion 15c selects a new foreground-side pixel 21a (step S309) and continuously performs the processing after step S302 on the selected foreground-side pixel 21a.

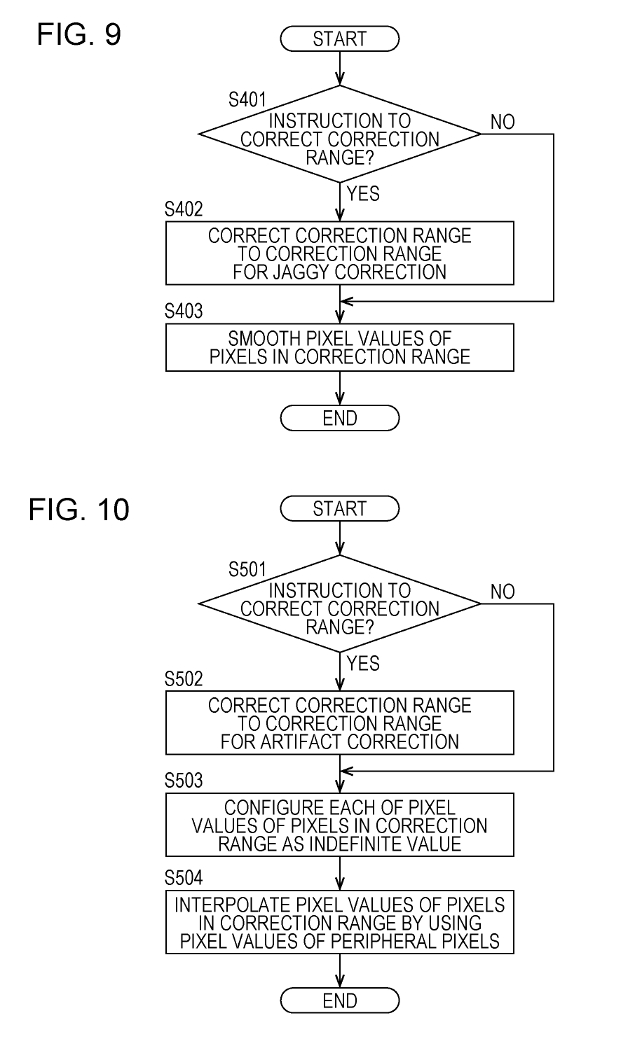

Next, the jaggy correction processing described in step S306 of FIG. 8 will be described. FIG. 9 is a flowchart depicting an example of the procedure of the jaggy correction processing.

First, the correction range configuring portion 15b determines whether or not there is an instruction to correct the correction range of the arbitrary viewpoint image (step S401). For example, it is assumed that this correction instruction is accepted from the user in advance. If there is an instruction to correct the correction range of the arbitrary viewpoint image (YES in step S401), the correction range configuring portion 15b corrects the correction range to a correction range for jaggy correction (step S402).

For example, as described by using FIGS. 2 and 3, the correction range configuring portion 15b configures a pixel range with the pixels 22d and 22e of the arbitrary viewpoint image data at both ends thereof as a target of correction, the pixels 22d and 22e corresponding to two pixels 21d and 21e away from the foreground-side pixel 21a by M pixels in the depth data after change of the viewpoint.

After the processing in step S402 or if the result is NO in step S401, the processing performing portion 16 smoothes the pixel values of the pixels in the correction range by the method whose example has been depicted in FIG. 4 (step S403). Then, the jaggy correction processing is ended.

Next, the artifact correction processing described in step S307 of FIG. 8 will be described. FIG. 10 is a flowchart depicting an example of the procedure of the artifact correction processing.

First, the correction range configuring portion 15b determines whether or not there is an instruction to correct the correction range of the arbitrary viewpoint image (step S501). If there is an instruction to correct the correction range of the arbitrary viewpoint image (YES in step S501), the correction range configuring portion 15b corrects the correction range to a correction range for artifact correction (step S502).

For example, as described by using FIGS. 2 and 3, the correction range configuring portion 15b configures a pixel range with the pixels 22a and 22e of the arbitrary viewpoint image at both ends thereof as a target of correction, the pixels 22a and 22e corresponding to the foreground-side pixel 21a and the pixel 22e in the region 20a, the pixel 22e being away from the foreground-side pixel 21a by M pixels, in the depth data after change of the viewpoint.

After the processing in step S502 or if the result is NO in step S501, as described by using FIG. 5, the processing performing portion 16 configures each of the pixel values of the pixels in the correction range as an indefinite value (step S503). Then, the processing performing portion 16 interpolates the pixel values of the pixels in the correction range by using the pixel values of the peripheral pixels (step S504). Then, the artifact correction processing is ended.

### Second Embodiment

In the first embodiment described above, an edge is extracted from depth data after change of the viewpoint and correction range configuration and selection of correction processing are performed based on the position of the extracted edge. However, since it is sometimes difficult to perform extraction of an edge in the depth data after change of the viewpoint, extraction of an edge may be performed by also using depth data before change of the viewpoint.

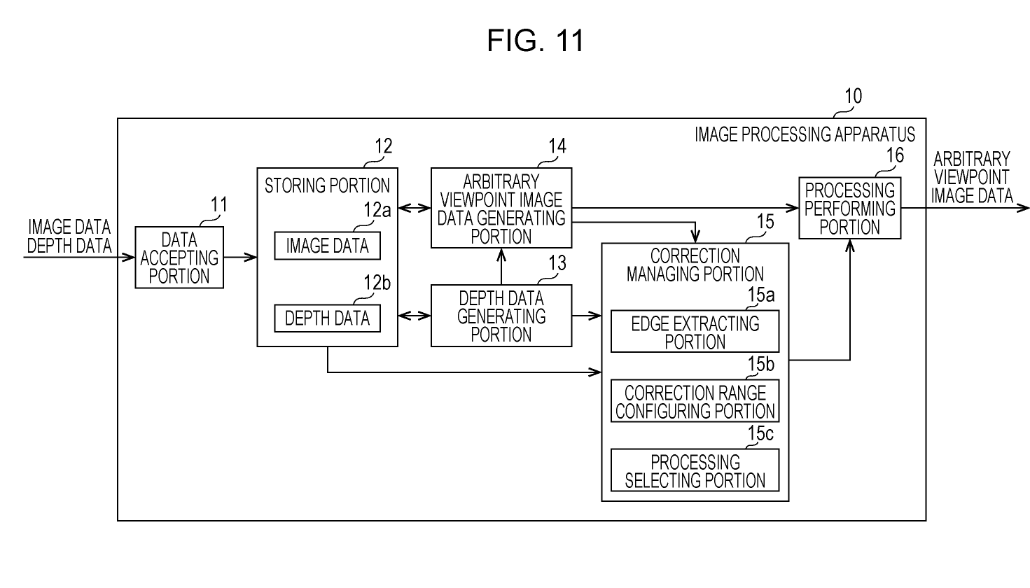

FIG. 11 is a diagram depicting an example of the configuration of an image processing device 10 according to a second embodiment of the present invention. The configuration of the image processing device 10 is the same as the configuration depicted in FIG. 1. However, the function of the edge extracting portion 15a is different from that of FIG. 1.

The edge extracting portion 15a depicted in FIG. 11 extracts an edge from the depth data after change of the viewpoint, the depth data being generated by the depth data generating portion 13, and reads the depth data before change of the viewpoint from the storing portion 12 and extracts an edge also from the depth data before change of the viewpoint. As this edge extraction method, the method described in the first embodiment can be used.

Then, the edge extracting portion 15a integrates the information on the edge extracted from the depth data before change of the viewpoint and the information on the edge extracted from the depth data after change of the viewpoint and outputs the information on the edge obtained as a result of integration to the correction range configuring portion 15b and the processing selecting portion 15c. This integration processing will be described in detail in the following description.

The correction range configuring portion 15b and the processing selecting portion 15c perform correction range configuration and selection of correction processing in the manner described in the first embodiment by using the information on the edge, the information being output from the edge extracting portion 15a.

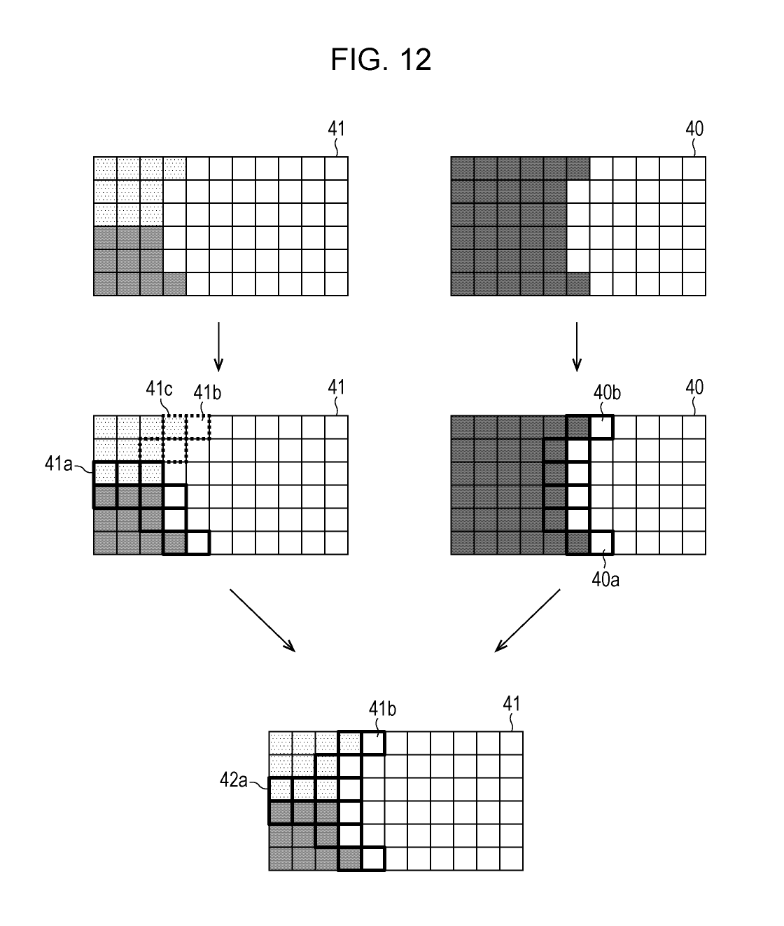

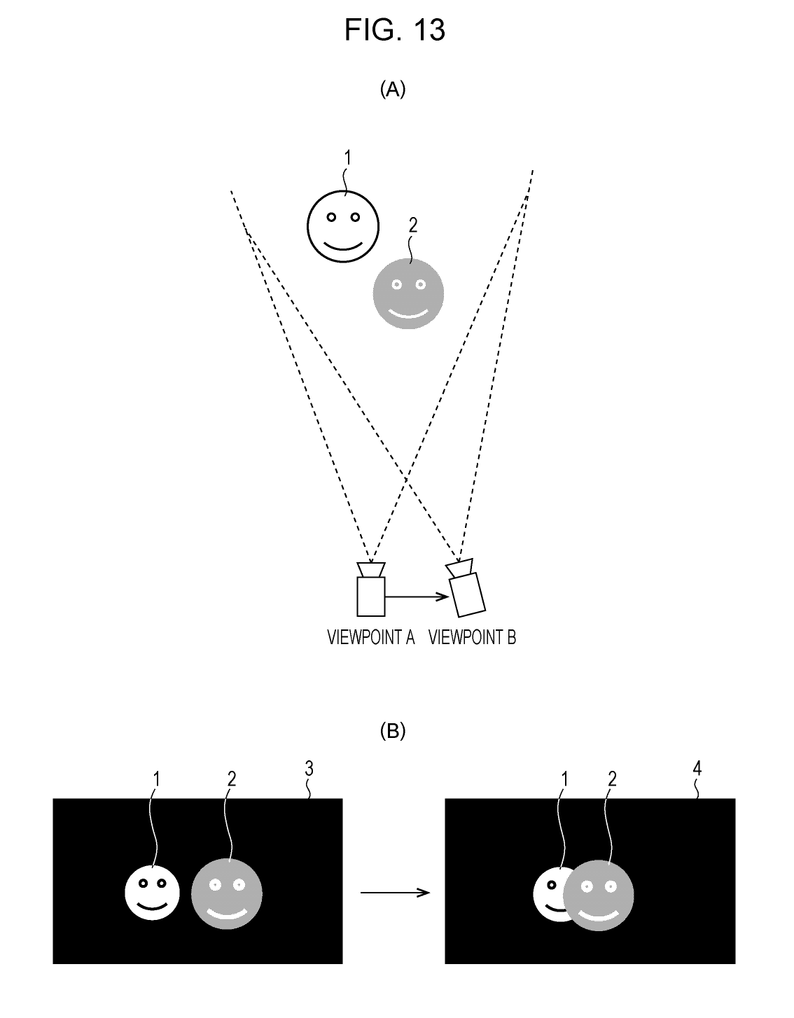

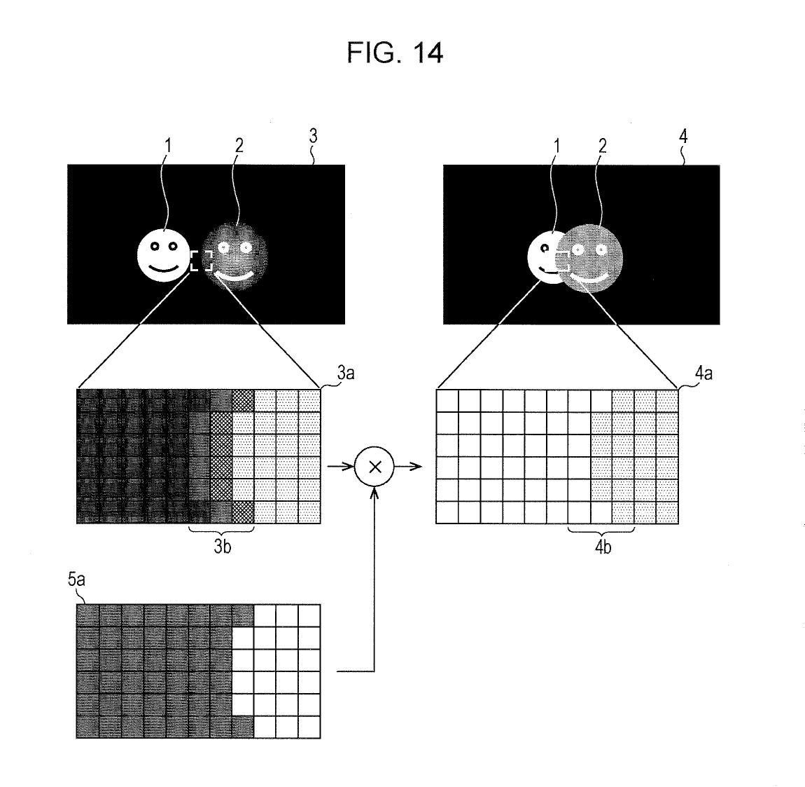

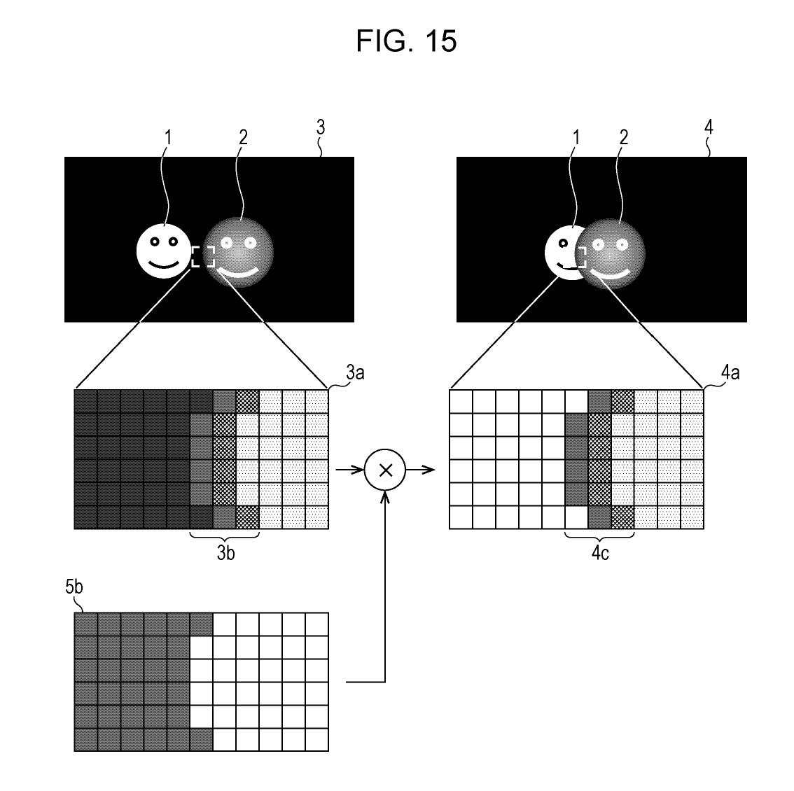

FIG. 12 is a diagram describing edge information integration processing according to the second embodiment of the present invention. In FIG. 12, depth data 40 before change of the viewpoint and depth data 41 after change of the viewpoint are depicted.

The edge extracting portion 15a extracts an edge 41a of the depth data 41 after change of the viewpoint and extracts an edge 40a of the depth data 40 before change of the viewpoint. Here, the description deals with a case where the viewpoint is shifted parallel to the x axis. An edge 41c is an edge that could not be extracted in the depth data 41 after change of the viewpoint because a difference between the pixel values of the foreground-side pixel and the background-side pixel is small.

Here, if the assumption is made that the coordinates of a pixel 40b included in the edge 40a extracted in the depth data 40 before change of the viewpoint are (x, y) and the coordinates of a pixel 41b, which is a point corresponding to the pixel 40b, in the depth data 41 after change of the viewpoint are (X, Y), X=x−d(x, y) and Y=y are obtained. d(x, y) is the disparity value of a pixel at coordinates (x, y) in the depth data 40 before change of the viewpoint.

Since this relational expression is also true for other pixels included in the edge 40a, the edge extracting portion 15a generates information on an edge 42a into which the edge 40a and the edge 41a are integrated by overlapping the edge 40a and the edge 41a after shifting the coordinates of the pixels included in the edge 40a only by −d(x, y).

Then, the correction range configuring portion 15b and the processing selecting portion 15c perform correction range configuration and selection of correction processing in the manner described in the first embodiment by using the information on an edge 42a.

As described above, in the second embodiment, since the edges 40a and 41a are extracted from the depth data 40 before change of the viewpoint and the depth data 41 after change of the viewpoint and correction range configuration and selection of correction processing are performed by using the information on these edges 40a and 41a, it becomes possible to perform extraction of the edge 42a easily, which makes it possible to generate a more natural arbitrary viewpoint image by suppressing the occurrence of a jaggy or an artifact at the time of generation of an arbitrary viewpoint image.

Now, the descriptions have been given with a focus on the embodiments of the image processing device and the image processing method, but the present invention is not limited to these embodiments. In each embodiment described above, the configurations and so forth depicted in the attached drawings are merely examples, and the configurations and so forth are not limited thereto and can be appropriately changed within a scope in which the advantages of the present invention are produced. That is, the present invention can be appropriately changed and then implemented within the intended scope of the present invention.

Moreover, in the above descriptions of each embodiment, descriptions have been given on the assumption that the components for implementing the functions of the image processing device are different portions, but it does not mean that the image processing device has to have portions that can be recognized actually as separate portions as described above. In the image processing device implementing the functions described in the above embodiments, the components for implementing the functions may be configured by using portions that are actually different from one another or all the components may be configured by using one portion. That is, in any implementation form, the form is simply required to have each component as a function.

Moreover, part or all of the components of the image processing device in each embodiment described above may be implemented as large scale integration (LSI) which is typically an integrated circuit. The components of an image processing device may be individually implemented as a chip or part or all of the components may be integrally implemented as a chip. Furthermore, the technique of circuit integration is not limited to LSI, and circuit integration may be implemented by a dedicated circuit or a general-purpose processor. Moreover, when a circuit integration technology that can replace LSI comes into being by the advance of the semiconductor technology, an integrated circuit implemented by that technology can also be used.

Furthermore, processing of each component may be implemented by recording a program for implementing the functions described in each embodiment described above on a computer-readable recording medium, reading the program recorded on the recording medium by a computer system provided with processors (a central processing unit (CPU), a micro processing unit (MPU)) and so forth, and causing the computer system to execute the program.

The “computer system” here can sometimes include an operating system (OS) and hardware such as peripheral devices. Moreover, in a case where the world wide web (WWW) system is used, it is assumed that the “computer system” includes a homepage offering environment (or display environment).

Moreover, the “computer-readable recording medium” refers to portable media such as a flexible disk, a magneto-optical disk, ROM, and a CD-ROM and storage media such as a hard disk incorporated into the computer system. Furthermore, it is assumed that the “computer-readable recording medium” includes what dynamically holds a program for a short time, such as a communication wire used when a program is sent via a network such as the Internet or a communication line such as a telephone line and what holds the program for a certain amount of time, such as volatile memory in the computer system functioning as a server or a client in that case.

Moreover, the above-described program may be provided for implementing part of the functions described above and may be a program that can implement the functions described above by being combined with a program that is already recorded on the computer system.

Furthermore, the image processing device described above may be provided in a stereoscopic image display device that displays a stereoscopic image. The stereoscopic image display device includes a display device and displays a stereoscopic image after change of the viewpoint by using depth data after change of the viewpoint and arbitrary viewpoint image data corresponding to the depth data.

### REFERENCE SIGNS LIST

1, 2 object
3 reference image
3a enlarged view of a reference image
3b, 24 gradation region
4, 30, 34 arbitrary viewpoint image
4a enlarged view of an arbitrary viewpoint image
4b jaggy region
5a, 5b, 12b depth data
4c artifact region
10 image processing device
11 data accepting portion
12 storing portion
12a image data
13 depth data generating portion
14 arbitrary viewpoint image data generating portion
15 correction managing portion
15a edge extracting portion
15b correction range configuring portion
15c processing selecting portion
16 processing performing portion
20a, 20b region of depth data after change of the viewpoint
23a, 23b region of an arbitrary viewpoint image after change of the viewpoint
21a to 21e pixel of depth data after change of the viewpoint
22a to 22e pixel of an arbitrary viewpoint image after change of the viewpoint
31 correction range information
31a correction range
32 3×3 Gaussian filter
33 arbitrary viewpoint image after jaggy correction
35 arbitrary viewpoint image after artifact correction
40 depth data before change of the viewpoint
40a edge in depth data before change of the viewpoint
40b pixel of depth data before change of the viewpoint
41 depth data after change of the viewpoint
41a edge in depth data after change of the viewpoint
41b pixel in depth data after change of the viewpoint
41c edge that could not be extracted
42a integrated edge

1-16. (canceled)

17. An image processing device that performs correction processing on viewpoint-changed image data in which a viewpoint is changed by converting image data having depth data, the device comprising:
a storing portion that stores depth data of each pixel of the viewpoint-changed image data;
an edge extracting portion that extracts an edge of the depth data stored in the storing portion;
a correction range configuring portion that configures a correction range of the viewpoint-changed image data, based on information on a position of the edge extracted by the edge extracting portion;
a processing selecting portion that selects correction processing that is applied to the viewpoint-changed image data, based on information on a pixel value of a pixel of the viewpoint-changed image data, the pixel corresponding to a pixel in the position of the edge extracted by the edge extracting portion, and a pixel value of a pixel of the viewpoint-changed image data, the pixel corresponding to a pixel away from the pixel in the position of the edge by a certain number of pixels; and
a processing performing portion that performs the correction processing selected by the processing selecting portion.

18. The image processing device according to claim 17, wherein
extraction of the edge is performed by using a two-dimensional filter.

19. The image processing device according to claim 17, wherein
the correction range configuring portion configures, as the correction range, a range of pixels of the viewpoint-changed image data, the pixels corresponding to pixels in a certain range including the pixel in the position of the edge.

20. The image processing device according to claim 17, wherein
the correction range configuring portion detects a size of an image formed by the viewpoint-changed image data and configures the correction range based on information on the size and the information on the position of the edge.

21. The image processing device according to claim 17, wherein
the correction range configuring portion accepts input information for configuring correction range, the input information being input by a user, and configures the correction range based on the input information.

22. The image processing device according to claim 17, wherein
the processing selecting portion specifies the certain number of pixels based on the correction range.

23. The image processing device according to claim 17, wherein
the correction range configuring portion configures the correction range at different ranges in accordance with the correction processing selected by the processing selecting portion.

24. The image processing device according to claim 17, wherein
the correction processing is correction processing for correcting a jaggy or correction processing for correcting an artifact.

25. The image processing device according to claim 17, wherein
the edge extracting portion further extracts an edge of depth data corresponding to image data before change of the viewpoint, and the correction range configuring portion configures the correction range based on information on the position of the edge of the depth data stored in the storing portion and information on a position of the edge of the depth data before change of the viewpoint.

26. An image processing method that performs correction processing on viewpoint-changed image data in which a viewpoint is changed by converting image data having depth data, the method comprising:
an edge extracting step of extracting an edge of depth data of each pixel of the viewpoint-changed image data stored in a storing portion;
a correction range configuring step of configuring a correction range of the viewpoint-changed image data, based on information on a position of the edge extracted in the edge extracting step;
a processing selecting step of selecting correction processing that is applied to the viewpoint-changed image data, based on information on a pixel value of a pixel of the viewpoint-changed image data, the pixel corresponding to a pixel in the position of the edge extracted in the edge extracting step, and a pixel value of a pixel of the viewpoint-changed image data, the pixel corresponding to a pixel away from the pixel in the position of the edge by a certain number of pixels; and
a processing performing step of performing the correction processing selected in the processing selecting step.

27. The image processing method according to claim 26, wherein
in the processing selecting step, the certain number of pixels is specified based on the correction range.

28. The image processing method according to claim 26, wherein
in the correction range configuring step, the correction range is configured at different ranges in accordance with the correction processing selected in the processing selecting step.

29. The image processing method according to claim 26, wherein
in the edge extracting step, an edge of depth data corresponding to image data before change of the viewpoint is further extracted, and, in the correction range configuring step, the correction range is configured based on information on the position of the edge of the depth data stored in the storing portion and information on a position of the edge of the depth data before change of the viewpoint.

30. A non-transitory computer readable recording medium storing a computer program causing a computer to perform the image processing method according to claim 26.

31. A stereoscopic image display device comprising:
the image processing device according to claim 17; and
a display device that displays the viewpoint-changed image data on which correction processing has been performed by the image processing device.
